(19) United States
(12) Patent Application Publication
(10) Pub. No.: US 2025/0273709 A1
(43) Pub. Date: Aug. 28, 2025

(54) FUEL CELL SYSTEM

(71) Applicant: Honda Motor Co., Ltd., Tokyo (JP)

(72) Inventors: Kotofumi Yanai, Saitama (JP); Kiyohide Hibino, Saitama (JP)

(21) Appl. No.: 19/053,816

(22) Filed: Feb. 14, 2025

(30) Foreign Application Priority Data
Feb. 26, 2024 (JP) 2024-026440

(51) Int. Cl. H01M 8/04223; H01M 8/04225; H01M 8/04302; H01M 8/0432; H01M 8/04492; H01M 8/04858

(52) U.S. Cl. CPC H01M 8/04268; H01M 8/04225; H01M 8/04302; H01M 8/0432; H01M 8/04492; H01M 8/0491

(57) ABSTRACT

Fuel cell system includes: fuel cell stack configured by stacking power generation cells each including electrolyte membrane and electrode; current limiting circuit configured to limit output current output from fuel cell stack to limit value or less; and electronic control unit including processor and memory coupled to processor. Electronic control unit is configured to perform: determining whether to perform warm-up of fuel cell stack when low-temperature startup operation that starts fuel cell stack from predetermined low-temperature state is executed; and controlling current limiting circuit to limit output current according to required power. Electronic control unit limits output current to first limit value or less when determination is made to perform warm-up, and limits output current to second limit value smaller than first limit value or less when determination is made not to perform warm-up.

### CROSS-REFERENCE TO RELATED APPLICATION

This application is based upon and claims the benefit of priority from Japanese Patent Application No. 2024-026440 filed on Feb. 26, 2024, the content of which is incorporated herein by reference.

### BACKGROUND OF THE INVENTION

### Field of the Invention

The present invention relates to a fuel cell system.

### Description of the Related Art

Use of a fuel cell as a drive source of a vehicle or the like can contribute to improvement of energy efficiency. As a technique related to such a fuel cell, conventionally, a device configured to limit an output current from a fuel cell stack when the stack is started under a low temperature environment is known. For example, in the device described in JP 2007-042566 A, in a case where a stack temperature at the time of startup is equal to or lower than a predetermined freezing temperature, the output current from the stack is limited so as to constantly increase a sweep current value from the fuel cell to a power supply destination, and the stack temperature is raised until the stack temperature becomes equal to or higher than the predetermined freezing temperature.

In the device described in JP 2007-042566 A, when the stack temperature is equal to or lower than the predetermined freezing temperature, temperature rise accompanied by power generation in the fuel cell stack, that is, warm-up is always performed. However, even when the fuel cell stack is started under a low temperature environment, there are a case where warm-up is performed and a case where warm-up is not performed, resulting in differences in the water content and temperatures of power generation cells. In such a case, limiting the output current as in the device described in JP 2007-042566 A may cause excessive current limitation.

### SUMMARY OF THE INVENTION

An aspect of the present invention is a fuel cell system, including: a fuel cell stack configured by stacking power generation cells each including an electrolyte membrane and an electrode; a current limiting circuit configured to limit an output current output from the fuel cell stack to a limit value or less; and an electronic control unit including a processor and a memory coupled to the processor. The electronic control unit is configured to perform: determining whether to perform a warm-up of the fuel cell stack when a low-temperature startup operation that starts the fuel cell stack from a predetermined low-temperature state is executed; and controlling the current limiting circuit to limit the output current according to a required power. The electronic control unit limits the output current to a first limit value or less when a determination is made to perform the warm-up, and limits the output current to a second limit value smaller than the first limit value or less when a determination is made not to perform the warm-up.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of an overall configuration of a fuel cell system according to an embodiment of the present invention;

FIG. 2 is a block diagram schematically illustrating an example of a control configuration of the fuel cell system according to the embodiment of the present invention;

FIG. 3 is a diagram for explaining characteristic of limit value set by a current control unit in FIG. 2; and

FIG. 4 is a flowchart illustrating an example of processing executed by an electronic control unit in FIG. 2.

### DETAILED DESCRIPTION OF THE INVENTION

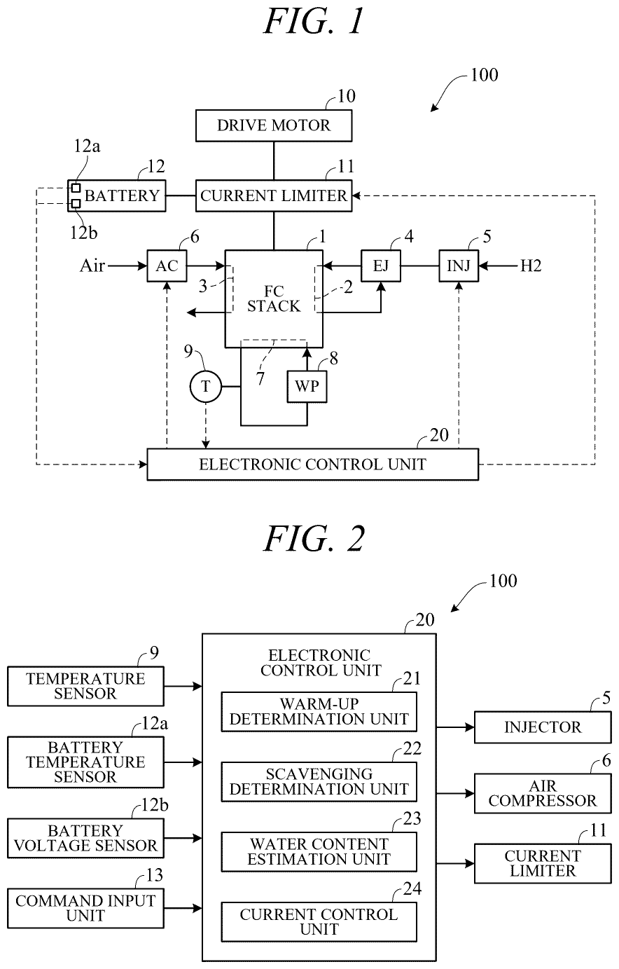

Hereinafter, embodiments of the present invention will be described with reference to FIGS. 1 to 4. FIG. 1 is a diagram schematically illustrating an example of an overall configuration of a fuel cell system 100 according to an embodiment of the present invention. As illustrated in FIG. 1, the fuel cell system 100 mainly includes a fuel cell stack 1 formed by stacking power generation cells, and an electronic control unit 20 that controls each unit of the fuel cell system 100. Each power generation cell of the fuel cell stack 1 has a membrane electrode assembly (MEA) in which electrodes (such as an electrode catalyst layer and a gas diffusion layer) are provided on both surfaces of a solid polymer electrolyte membrane. The fuel cell system 100 is mounted on a vehicle, for example, and can generate electric power for driving the vehicle. The fuel cell system 100 can be mounted on a moving body, such as an aircraft or a ship, other than a vehicle, a robot, or various types of industrial machine.

A fuel gas containing hydrogen is supplied to an anode electrode of each power generation cell of the fuel cell stack 1 through an anode flow path 2, and an oxidant gas such as air containing oxygen is supplied to a cathode electrode through a cathode flow path 3. Accordingly, an electrochemical reaction proceeds in the electrode of each power generation cell, and power generation is performed in the fuel cell stack 1.

A fuel gas tank storing high-pressure fuel gas is connected to the anode flow path 2 via an ejector 4 and an injector 5, and the fuel gas in the fuel gas tank is supplied to the anode flow path 2. The fuel gas supplied to the anode flow path 2 is partially used by the anode electrode, and then discharged from the anode flow path 2 as a fuel exhaust gas. The fuel exhaust gas discharged from the anode flow path 2 is sucked through the ejector 4 after water is separated through a gas-liquid separator (not illustrated), and is supplied to the anode flow path 2 again.

An air compressor 6 for supplying an oxidant gas is connected to the cathode flow path 3, and the oxidant gas compressed by the air compressor 6 is supplied to the cathode flow path 3. The oxidant gas supplied to the cathode flow path 3 is partially used in the cathode electrode, and then discharged from the cathode flow path 3 to the outside as an oxidant exhaust gas.

A cooling flow path 7 through which a cooling medium circulates is also provided inside the fuel cell stack 1. A water pump 8 that circulates the cooling medium through a radiator (not illustrated) is connected to the cooling flow path 7. A stack temperature sensor 9 is provided near the outlet of the cooling flow path 7 and detects the temperature of the cooling medium discharged from the cooling flow path 7. Since the temperature of the cooling medium discharged from the cooling flow path 7 represents the overall internal temperature (stack temperature) of the fuel cell stack 1, the stack temperature sensor 9 can detect the stack temperature from the temperature of the cooling medium discharged from the cooling flow path 7.

The fuel cell stack 1 is electrically connected to a drive motor (motor generator) 10 via metal terminal plates sandwiching the stacked body of the power generation cells. A current limiter (current limiting circuit) 11 is interposed between the fuel cell stack 1 and the drive motor 10, and the electric power generated by the fuel cell stack 1 is supplied to the drive motor 10 via the current limiter 11. The current limiter 11 limits a magnitude (current value) of an output current output from the fuel cell stack 1 to a predetermined limit value or less.

A battery 12 can be electrically connected to the current limiter 11 via a DC/DC converter (not illustrated). In this case, a part or all of the electric power generated by the fuel cell stack 1 can be stored in the battery 12 through the current limiter 11. In addition, the electric energy generated by the drive motor 10 for vehicle traveling at the time of regenerative braking of the vehicle can be stored in the battery 12 via the current limiter 11. In addition, the electric power stored in the battery 12 can be supplied to the drive motor 10 via the current limiter 11 as necessary.

The battery 12 is provided with a battery temperature sensor 12a that detects the temperature (battery temperature) of the battery 12 and a battery voltage sensor 12b that detects the voltage (battery voltage) of the battery 12. A state of charge (SOC) of the battery 12 can be estimated on the basis of the battery voltage detected by the battery voltage sensor 12b.

FIG. 2 is a block diagram schematically illustrating an example of a control configuration of the fuel cell system 100. The electronic control unit 20 of the fuel cell system 100 includes a computer having a CPU, a RAM, a ROM, an I/O interface, and other peripheral circuits. As illustrated in FIGS. 1 and 2, sensors such as the stack temperature sensor 9, the battery temperature sensor 12a, and the battery voltage sensor 12b are connected to the electronic control unit 20, and a detection value is input from each sensor to the electronic control unit 20. In addition, each unit of the fuel cell system 100 such as the injector 5, the air compressor 6, and the current limiter 11 is connected to the electronic control unit 20, and the electronic control unit 20 controls each unit of the fuel cell system 100.

As illustrated in FIG. 2, the electronic control unit 20 is also connected to a command input unit 13 that inputs various commands such as startup and request output of the fuel cell system 100. The command input unit 13 includes, for example, an ignition switch, an accelerator opening sensor, and the like of a vehicle using the drive motor 10 as a traveling drive source. When a startup command of the fuel cell system 100 is input from the command input unit 13, the electronic control unit 20 controls the injector 5 and the air compressor 6 to supply the fuel gas and the oxidant gas to the fuel cell stack 1 so that the fuel cell stack 1 generates power. In addition, the electronic control unit 20 calculates the flow rates of the fuel gas and the oxidant gas to be supplied to the fuel cell stack 1 on the basis of the detection value of each sensor and the request output input from the command input unit 13, and controls the injector 5 and the air compressor 6 according to the calculation result. In addition, the electronic control unit 20 calculates a limit value of the output current from the fuel cell stack 1 on the basis of the detection value of each sensor, and controls the current limiter 11 according to the calculation result.

As illustrated in FIG. 2, the electronic control unit 20 includes a warm-up determination unit 21, a scavenging determination unit 22, a water content estimation unit 23, and a current control unit 24 as functional configurations, and functions as the warm-up determination unit 21, the scavenging determination unit 22, the water content estimation unit 23, and the current control unit 24.

When a low-temperature startup operation for starting the fuel cell stack 1 from a predetermined low-temperature state is executed, the warm-up determination unit 21 determines whether or not to perform the warm-up of the fuel cell stack 1. The predetermined low-temperature state is a state in which the stack temperature detected by the stack temperature sensor 9 is equal to or lower than a temperature at which warm-up may be required. An outside air temperature sensor that detects an environmental temperature around the fuel cell stack 1, for example, an outside air temperature may be provided, and a state in which the outside air temperature detected by the outside air temperature sensor is equal to or lower than the temperature at which warm-up may be required may be set as a predetermined low-temperature state. In particular, under a freezing point, the water generated in each power generation cell of the fuel cell stack 1 may be frozen. However, the predetermined low-temperature state includes not only a state in which the stack temperature or the outside air temperature is below the freezing point, but also a state in which the temperature is equal to or lower than a temperature at which warm-up may be required even if the temperature is, for example, 0° C. or higher.

When the startup command of the fuel cell system 100 is input from the command input unit 13, the warm-up determination unit 21 determines whether or not the stack temperature detected by the stack temperature sensor 9 (or the outside air temperature detected by the outside air temperature sensor) is equal to or lower than the temperature at which warm-up may be required. In a case where the stack temperature is equal to or lower than the temperature at which warm-up may be required, the warm-up determination unit 21 determines that the low-temperature startup operation of the fuel cell stack 1 is executed, and in a case where the stack temperature exceeds the temperature at which warm-up may be required, the warm-up determination unit 21 determines that the low-temperature startup operation is not executed. When it is determined that the low-temperature startup operation is executed, the warm-up determination unit 21 determines whether or not to perform the warm-up of the fuel cell stack 1 on the basis of whether scavenging and drying for discharging the moisture of each of the flow paths 2 and 3 to the outside have been performed after the previous operation stop of the fuel cell stack 1, an elapsed time from the previous operation stop to the current startup, a stack temperature at the current startup, an outside air temperature, or the like.

The warm-up of the fuel cell stack 1 is executed as low-efficiency power generation in which the supply amount of the oxidant gas to the cathode flow path 3 is reduced as compared with the normal operation of the fuel cell stack 1. In the low-efficiency power generation, the supply amount of the oxidant gas to the cathode flow path 3 is reduced as compared with that during the normal operation, and a ratio (air stoichiometric ratio) of the air supply amount to the theoretical air consumption amount necessary for power generation (electrochemical reaction) in the fuel cell stack 1 is reduced as compared with that during the normal operation. In this case, since an oxygen concentration at the interface of the cathode electrode is lower compared with that during the normal operation, in order to maintain the current value, it is necessary to increase a probability that electrons are exchanged between the cathode electrode and oxygen by consuming a voltage (concentration overvoltage). This concentration overvoltage causes the output voltage to be lower compared with that during the normal operation, resulting in low-efficiency power generation in which the output voltage is lower compared with the IV characteristic (reference IV characteristic) during the normal operation, and a power generation loss increases compared with that during the normal operation. Since the power generation loss is converted into thermal energy to raise the temperature of the fuel cell stack 1, the temperature of the fuel cell stack 1 can be raised more quickly than during the normal operation by performing the low-efficiency power generation.

A heater may be provided around the fuel cell stack 1, and the warm-up of the fuel cell stack 1 may be executed by the heater instead of or in addition to the low-efficiency power generation. In this case, in addition to whether or not to perform the warm-up of the fuel cell stack 1, the warm-up determination unit 21 determines whether to perform the warm-up of the fuel cell stack 1 only by the low-efficiency power generation, only by the heater, or by the combination of the low-efficiency power generation and the heater.

Before executing the low-temperature startup operation, more specifically, after the previous operation stop of the fuel cell stack 1 and before the current startup, the scavenging determination unit 22 determines whether or not scavenging for discharging moisture (in each of flow paths 2 and 3) in the fuel cell stack 1 to the outside has been performed.

The water content estimation unit 23 estimates the water content of each power generation cell (mainly MEA) on the basis of the determination results by the warm-up determination unit 21 and the scavenging determination unit 22. More specifically, when the warm-up determination unit 21 determines to perform the low-efficiency power generation as warm-up, the water content is estimated as a first predetermined value, and when the warm-up determination unit 21 determines not to perform the low-efficiency power generation as warm-up, the water content is estimated as a second predetermined value smaller than the first predetermined value. That is, in a case where the low-efficiency power generation in which water is generated by an electrochemical reaction is performed, the water content is estimated as a larger value than in a case where the low-efficiency power generation is not performed.

In addition, the water content (first predetermined value, second predetermined value) when the scavenging determination unit 22 determines that scavenging has been performed is estimated (corrected) to be smaller than the water content when the scavenging determination unit 22 determines that scavenging has not been performed. The water content estimation unit 23 may further correct the water content on the basis of an operation history such as a current value, a stack temperature, and an operation time at the time of the previous operation stop of the fuel cell stack 1, an elapsed time from the time of the previous operation stop to the time of the current startup, a stack temperature at the time of the current startup, and an outside air temperature. That is, since each of flow paths 2 and 3 is sealed while the operation of the fuel cell stack 1 is stopped, the water content at the time of the current startup can be accurately estimated (corrected) on the basis of the operation history from the time of the previous operation stop to the time of the current startup. In a case where the water content is estimated on the basis of the presence or absence of warm-up or scavenging and the operation history, unlike a case where the water content is estimated on the basis of the resistance (membrane resistance) of the electrolyte membrane, it is not necessary to provide an additional type of sensor such as an impedance sensor, so that the configuration of the whole system can be simplified.

The current control unit 24 controls the output current output from the fuel cell stack 1 according to the required power. More specifically, the supply amounts of the fuel gas and the oxidant gas are calculated according to the reference IV characteristic of the fuel cell stack 1 so as to satisfy the required output input from command input unit 13, and the injector 5 and the air compressor 6 are controlled according to the calculation result.

The current control unit 24 further controls the current limiter 11 to perform output current limitation for limiting the output current output from the fuel cell stack 1 to the limit value or less. That is, during the low-temperature startup operation, the stack temperature is low and a saturated water vapor pressure is low, so that water generated by power generation (electrochemical reaction) in the fuel cell stack 1 is not appropriately discharged, which may cause flooding that water stagnates at the interface of the cathode electrode. In this case, the electrochemical reaction is delayed due to the insufficient oxygen concentration at the interface of the cathode electrode, the output voltage rapidly decreases, the operation with the reference IV characteristic becomes impossible, and the power generation state becomes unstable. In addition, for example, at the time of low-temperature startup operation in which scavenging and drying are performed after the previous operation stop of the fuel cell stack 1 and warm-up is not performed at the time of the current startup, dry-out in which the MEA is dried may occur. In this case, the proton conductivity of the electrolyte membrane decreases or the effective catalyst area of the electrode catalyst layer decreases, so that the electrochemical reaction is delayed, the output voltage rapidly decreases, the operation with the reference IV characteristic becomes impossible, and the power generation state becomes unstable.

The current control unit 24 sets a limit value on the basis of the stack temperature detected by the stack temperature sensor 9 and the water content estimated by the water content estimation unit 23, and limits the output current from the fuel cell stack 1 to the limit value or less. The limit value is determined in advance by a test as a maximum current value in a range in which a decrease in output voltage due to flooding or dry-out does not occur according to the stack temperature and the water content. The characteristic of the limit value according to the stack temperature and the water content is stored in the electronic control unit 20 (ROM).

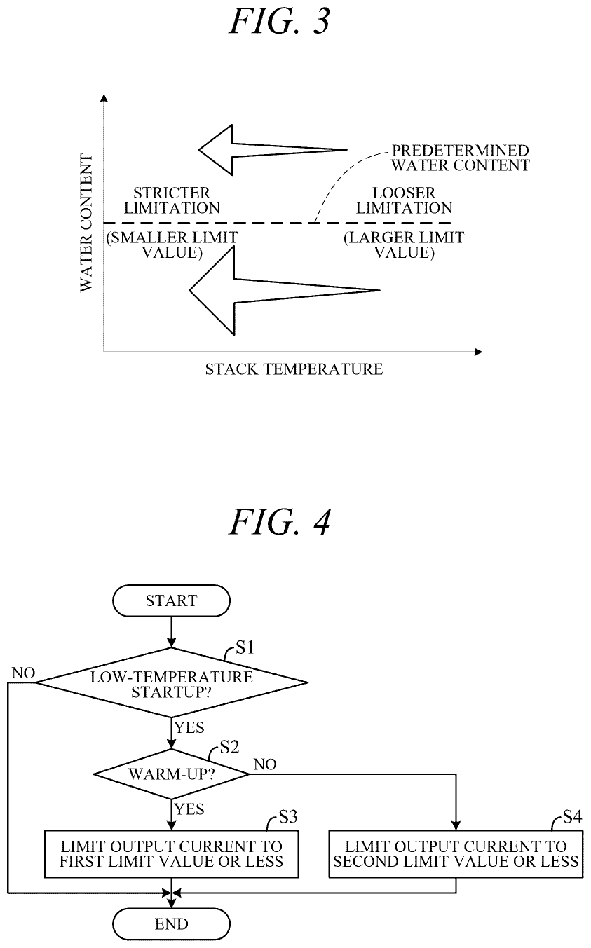

FIG. 3 is a diagram for explaining the characteristic of the limit value set by the current control unit 24. As illustrated in FIG. 3, the limit value is set as a smaller current value as the stack temperature is lower (that is, the lower the stack temperature, the stricter the output current limitation is set to be performed). In addition, the limit value (current value) when the water content is less than predetermined water content is set to be smaller than the limit value when the water content is equal to or more than the predetermined water content (that is, the stricter output current limitation is set to be performed than when the water content is equal to or more than the predetermined water content). After the fuel cell stack 1 is started and reaches the stack temperature (for example, about 50° C. to 90° C.) during the normal operation, the decrease in output voltage due to flooding or dry-out does not occur as long as the operation according to the reference IV characteristic is performed, and it is not necessary to perform the output current limitation. During the startup until the fuel cell stack 1 reaches the stack temperature during the normal operation, particularly during the low-temperature startup, the decrease in output voltage due to flooding or dry-out may occur depending on the amount of water present inside the fuel cell stack 1.

In such a region, it is possible to suppress the decrease in output voltage due to flooding or dry-out by setting the limit value according to the stack temperature and the water content and performing the output current limitation. When a maximum current value in a range in which the decrease in output voltage due to flooding or dry-out does not occur is set as the limit value according to the stack temperature and the water content, excessive output limitation can be suppressed, and the output performance of the fuel cell stack 1 can be secured.

When the warm-up determination unit 21 determines to perform the low-efficiency power generation as warm-up, the water content estimation unit 23 estimates the water content as the first predetermined value with relatively large water content, and the current control unit 24 sets the limit value as a relatively large (loose) first limit value corresponding to the first predetermined value. When the warm-up determination unit 21 determines not to perform the low-efficiency power generation as warm-up, the water content estimation unit 23 estimates the water content as the second predetermined value with relatively small water content, and the current control unit 24 sets the limit value as a relatively small (strict) second limit value corresponding to the second predetermined value. In other words, when the warm-up determination unit 21 determines to perform the low-efficiency power generation as warm-up, the current control unit 24 limits the output current to the first limit value or less, and when the warm-up determination unit 21 determines not to perform the low-efficiency power generation, the current control unit 24 limits the output current to the second limit value smaller than the first limit value or less. Note that the limit values (the first limit value and the second limit value) may include a current value in a state where current limitation is not performed (that is, a maximum current value during the normal operation).

Note that in a case where the warm-up of the fuel cell stack 1 is performed only by the heater, the warm-up determination unit 21 determines not to perform the low-efficiency power generation as warm-up, the water content estimation unit 23 estimates the water content as the second predetermined value having a relatively small water content, and the current control unit 24 sets the second limit value. The power generation in the case of performing warm-up by the heater, starts after the stack temperature becomes higher than that in the case of not performing warm-up at all, and thus the second limit value in the case of performing warm-up by the heater is set to be larger (looser) than the second limit value in the case of not performing warm-up at all.

In addition, when the scavenging determination unit 22 determines that scavenging has been performed, the water content estimation unit 23 estimates the water content (first predetermined value, second predetermined value) to be smaller, and the current control unit 24 sets the limit value (first limit value, second limit value) to be smaller (stricter) compared to that when it is determined that scavenging has not been performed. In other words, the current control unit 24 sets the limit value when the scavenging determination unit 22 determines that scavenging has been performed, to be smaller than the limit value when the scavenging determination unit 22 determines that scavenging has not been performed.

During the output current limitation by the current control unit 24, the request output input from the command input unit 13 may not be satisfied. In this case, the electric power from the battery 12 may be supplied to the drive motor 10 on condition that the SOC based on the battery temperature detected by the battery temperature sensor 12a and the battery voltage detected by the battery voltage sensor 12b is equal to or larger than a predetermined threshold.

FIG. 4 is a flowchart illustrating an example of processing executed by the electronic control unit 20. The processing of FIG. 4 starts when a startup command of the fuel cell system 100 is input from the command input unit 13. As illustrated in FIG. 4, first, in S1 (S: processing step), the stack temperature detected by the stack temperature sensor 9 is equal to or lower than the temperature at which warm-up may be required, and it is determined whether or not the low-temperature startup operation is executed. If a negative determination is made in S1, the processing ends, and if an affirmative determination is made in S1, the processing proceeds to S2. In S2, whether or not to perform the warm-up of the fuel cell stack 1 it is determined on the basis of whether or not scavenging and drying have been performed after the previous operation stop of the fuel cell stack 1, an elapsed time from the previous operation stop to the current startup, a stack temperature at the current startup, an outside air temperature, or the like. If an affirmative determination is made in S2, the processing proceeds to S3, a limit value (first limit value) is set on the basis of the stack temperature detected by the stack temperature sensor 9 and the water content estimated by the water content estimation unit 23, and the output current limitation is limited to the first limit value or less. If a negative determination is made in S2, the processing proceeds to S4, a limit value (second limit value) is set on the basis of the stack temperature detected by the stack temperature sensor 9 and the water content estimated by the water content estimation unit 23, and the output current limitation is limited to the second limit value or less.

According to the present embodiment, the following operations and effects can be achieved.
(1) The fuel cell system 100 includes: the fuel cell stack 1 configured by stacking power generation cells each having an electrolyte membrane and an electrode; the warm-up determination unit 21 that determines whether or not to perform warm-up of the fuel cell stack 1 when a low-temperature startup operation that starts the fuel cell stack 1 from a predetermined low-temperature state is executed; and the current control unit 24 that controls an output current output from the fuel cell stack 1 according to a required power (FIGS. 1 and 2). The current control unit 24 limits the output current to the first limit value or less when the warm-up determination unit 21 determines to perform warm-up, and limits the output current to the second limit value smaller than the first limit value or less when the warm-up determination unit 21 determines not to perform warm-up (FIG. 4). As described above, by setting the limit value according to the presence or absence of warm-up affecting the water content or the temperature of the power generation cell, it is possible to set an appropriate limit value according to the water content or the temperature of the power generation cell, and thus, it is possible to suppress excessive current limitation.
(2) The fuel cell system 100 further includes: the scavenging determination unit 22 that determines whether or not scavenging for discharging moisture in the fuel cell stack 1 to the outside has been performed before the low-temperature startup operation is performed (FIG. 2). The current control unit 24 sets the limit value (first limit value, second limit value) when the scavenging determination unit 22 determines that scavenging has been performed to be smaller than the limit value when the scavenging determination unit 22 determines that scavenging has not been performed. As described above, by setting the limit value according to the presence or absence of scavenging affecting the water content of the power generation cell, it is possible to set a more appropriate limit value according to the water content of the power generation cell, and it is possible to further suppress excessive current limitation.
(3) The fuel cell system 100 further includes: the stack temperature sensor 9 that detects a temperature (stack temperature) of the fuel cell stack 1 (FIGS. 1 and 2). The current control unit 24 sets the limit value (first limit value, second limit value) on the basis of the stack temperature detected by the stack temperature sensor 9 (S3 and S4 in FIGS. 3 and 4). The limit value is set to be smaller as the stack temperature decreases (FIG. 3). By setting an appropriate limit value according to the stack temperature, it is possible to appropriately suppress excessive output limitation.
(4) The fuel cell system 100 further includes: the water content estimation unit 23 that estimates the water content of the power generation cell on the basis of the determination results by the warm-up determination unit 21 and the scavenging determination unit 22 (FIGS. 1 and 2). The current control unit 24 further sets the limit value (first limit value, second limit value) on the basis of the water content estimated by the water content estimation unit 23 (S3 and S4 in FIGS. 3 and 4). The limit value when the water content is less than predetermined water content is set to be smaller than the limit value when the water content is equal to or more than the predetermined water content (FIG. 3). When a maximum current value in a range in which the decrease in output voltage due to flooding or dry-out does not occur is set as the limit value according to the stack temperature and the water content, excessive output limitation can be suppressed more appropriately.

In the above embodiment, an example has been described in which a temperature of a cooling medium discharged from the cooling flow path 7 is detected as the stack temperature in FIG. 1 and the like, but a physical quantity representing the temperature of the fuel cell stack is not limited to such an example. For example, a temperature of a gas flowing through each of flow paths 2 and 3 may be detected as the physical quantity representing the temperature of the fuel cell stack, or the temperature of the fuel cell stack 1 itself (for example, each power generation cell) may be detected.

The above embodiment can be combined as desired with one or more of the aforesaid modifications. The modifications can also be combined with one another.

According to the present invention, it becomes possible to set an appropriate limit value according to the water content or the temperature of the power generation cell to suppress excessive current limitation.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack configured by stacking power generation cells each including an electrolyte membrane and an electrode;
a current limiting circuit configured to limit an output current output from the fuel cell stack to a limit value or less; and
an electronic control unit including a processor and a memory coupled to the processor, wherein
the electronic control unit is configured to perform:
determining whether to perform a warm-up of the fuel cell stack when a low-temperature startup operation that starts the fuel cell stack from a predetermined low-temperature state is executed; and
controlling the current limiting circuit to limit the output current according to a required power, wherein
the electronic control unit limits the output current to a first limit value or less when a determination is made to perform the warm-up, and limits the output current to a second limit value smaller than the first limit value or less when a determination is made not to perform the warm-up.

2. The fuel cell system according to claim 1, wherein
the electronic control unit is further configured to perform:
determining whether a scavenging for discharging moisture in the fuel cell stack to outside has been performed before the low-temperature startup operation is performed, wherein
the electronic control unit sets the first limit value and the second limit value when it is determined that the scavenging has been performed to be smaller than the first limit value and the second limit value when it is determined that the scavenging has not been performed.

3. The fuel cell system according to claim 1, further comprising:
a stack temperature sensor configured to detect a temperature of the fuel cell stack, wherein
the electronic control unit sets the first limit value and the second limit value based on the temperature detected by the stack temperature sensor, wherein
the first limit value and the second limit value are set to be smaller as the temperature decreases.

4. The fuel cell system according to claim 3, wherein
the electronic control unit is further configured to perform:
estimating a water content of the power generation cell based on a determination result whether to perform the warm-up, wherein
the electronic control unit further sets the first limit value and the second limit value based on the water content estimated, wherein
the first limit value and the second limit value when the water content is less than a predetermined water content are set to be smaller than the first limit value and the second limit value when the water content is the predetermined water content or more.

5. The fuel cell system according to claim 1, wherein
the electronic control unit is configured to perform the warm-up as low-efficiency power generation.

6. The fuel cell system according to claim 5, wherein
fuel gas containing hydrogen and oxidant gas such as air containing oxygen are supplied to the fuel cell stack, wherein
an electrochemical reaction of the fuel gas and the oxidant gas proceeds in the electrode and power generation is performed, wherein
in the low-efficiency power generation, supply amount of the oxidant gas to the fuel cell stack is reduced as compared with a normal operation.
